(19) United States
(12) Patent Application Publication
(10) Pub. No.: US 2006/0239251 A1
(43) Pub. Date: Oct. 26, 2006

(54) Multi-user media client for communication devices

(76) Inventors: Jesse W. Bennett, Apex, NC (US); William Richard Osborn, Cary, NC (US); Daniel James Robertson, Puttenham (GB)

Correspondence Address: COATS & BENNETT/SONY ERICSSON, 1400 CRESCENT GREEN, SUITE 300, CARY, NC, 27511, US

(21) Appl. No.: 11/370,151

(22) Filed: Mar. 7, 2006

Related U.S. Application Data
(63) Continuation-in-part of application No. 11/114,427, filed on Apr. 26, 2005.
(63) Continuation-in-part of application No. 11/114,430, filed on Apr. 26, 2005.
(60) Provisional application No. 60/754,925, filed on Dec. 29, 2005.

(51) Int. Cl. H04L 12/66

(52) U.S. Cl. 370/352

(57) ABSTRACT

A SIP client for a communication device includes a user agent to communicate with a user application in the communication device. The user agent provides a high-level application interface to the user application and translates user commands into corresponding signaling and media operations. The same user agent may be shared by a plurality of user applications. A signaling agent controlled by the user agent performs signaling operations necessary to establish and maintain communication sessions. To avoid signaling overhead on a high cost network, the SIP client can be located in a remote network so signaling messages do not need to traverse the high cost network.

### RELATED APPLICATIONS

This application is a continuation-in-part of U.S. patent application Ser. No. 11/114,427 filed Apr. 26, 2005 and U.S. patent application Ser. No. 11/114,430 filed Apr. 26, 2005, which are incorporated herein by reference. This application claims the benefit of U.S. Provisional Patent Application 60/754,925 filed on Dec. 29, 2005, which is incorporated herein by reference.

### BACKGROUND OF THE INVENTION

The IP multimedia subsystem (IMS) was developed to provide a common standardized architecture and standardized interfaces for providing IP services in a mobile networking environment. The IMS network is not dependent on the access technology and will interoperate with virtually any cellular network. IMS uses the session initiation protocol (SIP) as the service control protocol, which allows operators to offer multiple applications simultaneously. The IMS standard is expected to speed the adoption of IP services on mobile terminals, allowing users to communicate via voice, video, or text using a single client on the mobile terminal.

Although IMS promises a richer experience to mobile subscribers, network operators are hesitant to invest in equipment to implement IMS until there are a sufficient number of subscribers with IMS capability to make the investment worthwhile. Most cellular telephones currently in use do not have a SIP client and lack IMS capabilities, so the pool of potential subscribers for IMS services is relatively small. Extending IMS capabilities to legacy mobile terminals that lack inherent IMS capabilities would provide a much broader market for network operators and encourage investment in IMS technology and equipment.

### SUMMARY OF THE INVENTION

The present invention relates to a SIP client that provides SIP and/or IMS capabilities to users of communication devices. In one exemplary embodiment, the SIP client includes a user agent that provides a high-level application interface to user applications to insulate a user application from the details of the underlying network protocols, and a signaling agent under the control of the user agent that performs signaling tasks necessary for establishing, modifying, and terminating communication sessions for media transfers. The user agent translates user commands from a user application into corresponding signaling operations. The user agent may be shared by a plurality of different users. The signaling agent generates the signaling messages to perform those signaling operations. The SIP client can reside in a server in a fixed communication network. In this case, the user application in a communication device can send commands over a communication network to the SIP client.

The high-level application interface provides inherent bandwidth compression as compared to the signaling messages generated by the signaling agent. This property can be used to reduce signaling overhead over low bandwidth, low speed, long latency, and/or high cost connections. For example, in a cellular network, the air interface has limited bandwidth. By locating the SIP client in the fixed network, an application residing in a mobile terminal needs to send only user commands to the SIP client. The SIP client then generates the signaling messages, which do not need to traverse the air interface. The SIP client does not need to be located in the cellular network, but could reside in any network that can be accessed from the cellular network. Thus, the SIP client can be located in a network that offers the lowest cost.

### BRIEF DESCRIPTION OF THE DRAWINGS

FIG. 1 illustrates a communication network 10 according to one exemplary embodiment of the invention

FIG. 2 illustrates the architecture of the SIP client according to the present invention.

FIG. 3 is a ladder diagram illustrating an exemplary procedure to establish a session between two users.

FIG. 4 illustrates an implementation of the SIP client to reduce signaling traffic in a cellular network.

FIG. 5 illustrates an implementation of the SIP client using a shared user agent.

### DETAILED DESCRIPTION OF THE INVENTION

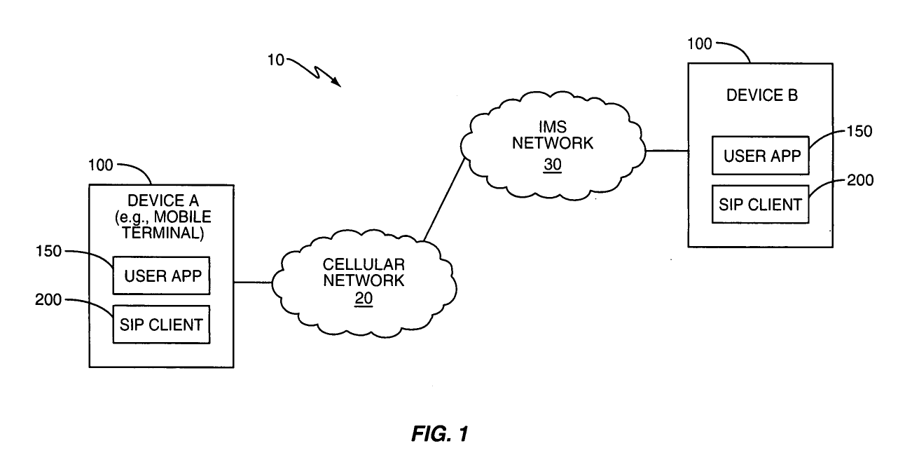

FIG. 1 illustrates a communication network 10 according to one exemplary embodiment of the invention. The mobile communication network 10 comprises a conventional cellular network 20 providing voice and/or data services, and an IP network 30 providing IP services that is interconnected with the cellular network 20. The cellular network 20, for example, may comprise a GSM, GPRS, EDGE, cdmaOne, cdma2000, WCDMS, or UMTS network, although other access technologies can also be used. The IP network 30 may, for example, comprise an IP Multimedia Subsystem (IMS) network. The IMS network 30 uses the Session Initiation Protocol (SIP) as a signaling protocol for communication between end devices. SIP is a text-based signaling protocol used for setting-up, modifying, and tearing down media sessions. SIP has also been extended for instant messaging and presence services. A gateway (not shown) connects the cellular network 20 and the IMS network 30. Two networked communication devices (NCDs) 100 are shown —a mobile terminal connected to the cellular network 20 and a computer connected to the IMS network 30. Each NCD 100 includes a SIP client 200 that interfaces with a user application 150. SIP client 200 functions as a SIP user agent to establish modify and terminate communication sessions between two or more end devices.

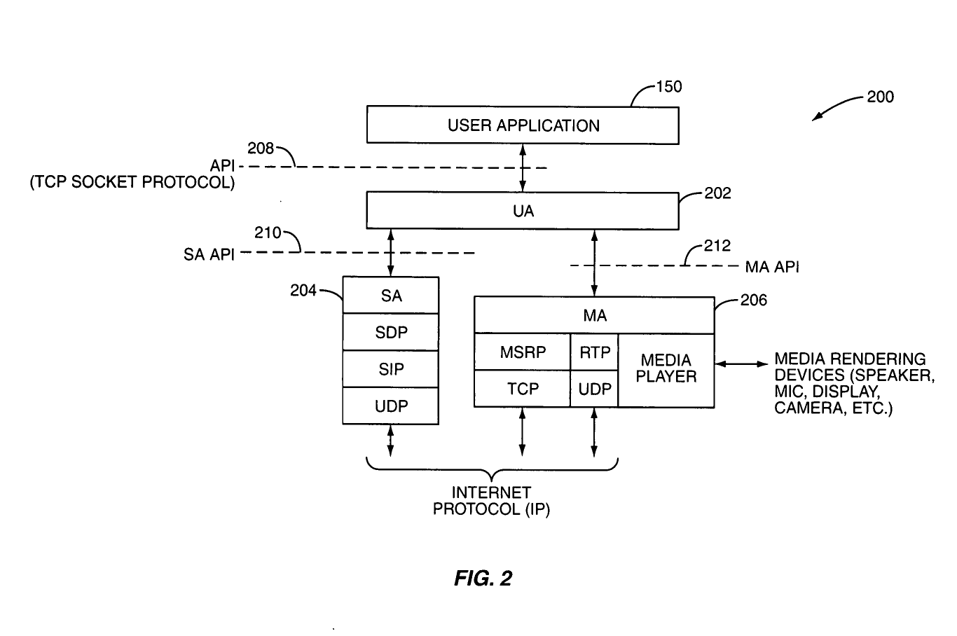

FIG. 2 illustrates the architecture of an exemplary SIP client 200. The SIP client 200 enables an NCD 100 to communicate with other NCDs 100 over a communication network. SIP client 200 provides a high level application interface that insulates user applications 150 from the details of the underlying network protocols. Media connections appear to the user applications 150 as simple data streams, a/k/a pipes, that can be manipulated with simple open, closed, read, and write commands.

SIP client 200 comprises three main components—a user agent (UA) 202, a signaling agent (SA) 204, and a media agent (MA 206) 206. UA 202 communicates with user application 150 and translates application commands into appropriate signaling and media operations. SA 204 and MA 206 operate under the control and direction of UA 202. The UA 202 has overall control over connection management, and delegates signaling and media management tasks to the SA 204 and MA 206, respectively. In the illustrated embodiment, SA 204 implements SIP and SDP protocols to handle signaling tasks. The SA 204 uses UDP over IP for transport of messages, but other session control protocols, such as H.323, could also be used. The signaling tasks include the set up, modification, and tear down of communication sessions, session parameters negotiations, remote device interrogations to determine capabilities, and presence detection. The MA 206 implements the Message Sessions Relay Protocol (MSRP) and the Real-Time Transport Protocol (RTP), and includes one or more media players to process and output media to media rendering devices. MA 206 manages media connections, routes media according to media type and user settings, and invokes media players to process media as required. The MA 206 uses TCP and/or UDP over IP for transport of RTP and MSRP messages.

In some realizations, a monolithic approach may be taken, which integrates the UA 202, SA 204, and MA 206 together in a single application. In the embodiment shown in FIG. 2, network interfaces 208, 210, and 212 between the UA 202, SA 204, and MA 206 enable implementations where the UA 202, SA 204, and MA 206 may be separate applications distributed within the communication network 10. Interfaces 208, 210, and 212 may use a TCP socket connection or other type of network interface allowing the UA 202, SA 204, and/or MA 206 to be remotely located from the user application 150.

The distributed approach has several advantages over the monolithic approach. The SIP client 200 may be located in a network server in the IMS 30 or other IP network and remotely accessed by an NCD 100 using, for example, telnet to open a socket connection. Thus, IP services can be provided to an NCD 100, such as a mobile terminal in a cellular network, that does not have inherent SIP capabilities. The separation of the UA 202, SA 204, and MA 206 allow these elements to be distributed within the network 10 so that the UA 202, SA 204, and MA 206 can reside in different locations within network 10. By locating the SIP client 200 in a network with low bandwidth or high latency, improved performance may be realized because the high level API for SIP client 200 reduces the amount of signaling over the air interface.

The SIP client 200 is implemented as a process running on a host device, such as a PC or mobile terminal. The host device includes memory in which to store code for implementing the present invention, one or more microprocessors to execute the code, and a communications interface to provide network access. UA 202, SA 204, and MA 206 may reside in different host devices. After it boots up, the SIP client 200 opens a server socket on a designated port, e.g., port 3500 for communications between the UA 202 and the user application 150. Any user application 150 wishing to communicate with the SIP client 200 can open a client socket on the same port. The port for communications between the UA 202 and the user application 150 may be specified in a configuration file. Different ports may be opened for communications between the UA 202 and the SA 204, or between the UA 202 and the MA 206. U.S. patent application Ser. No. 11/114,427 and U.S. patent application Ser. No. 11/114,430, both filed on Apr. 26, 2005, describe application interfaces for a UA 202. These applications are incorporated herein by reference.

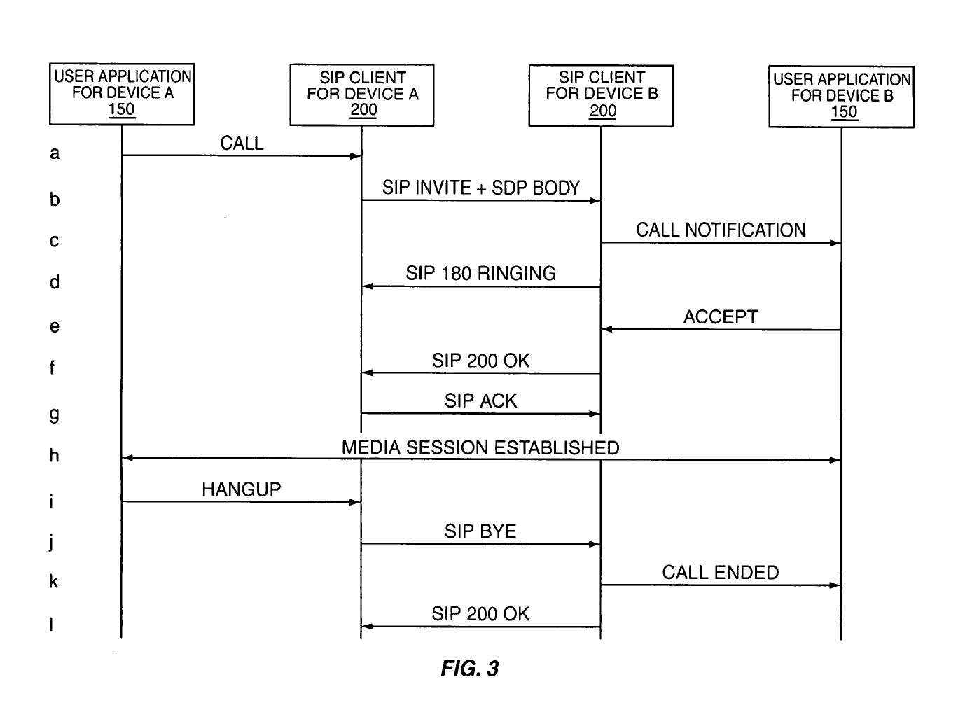

FIG. 3 shows a simple SIP exchange between two SIP-enabled NCDs 100. The two SIP-enabled NCDs 100 may be mobile telephones, computers, personal digital assistants (PDAs), or any other type of communication device connected to a network and having access to the Internet. This example assumes that the devices know each other's IP addresses. The user application 150 in the calling device, Device A in this example, sends a CALL request to the SIP client 200 in Device A (step a). The SIP client 200 initiates call set-up by sending a SIP INVITE request to the SIP client 200 in the called party, Device B (step b). The INVITE request typically includes a SDP message body that describes the type of call that is being requested and gives the session parameters. For example, the requested session could be a simple audio session, a multimedia session, a videoconference, or a gaming session. The SIP client 200 notifies the called party (step c) and sends a 180 RINGING response to the SIP client 200 in Device A to indicate that the called party has received the request and that the called party is being alerted (step d). The 180 RINGING response is known as a provisional response. When the called party accepts the call (step e), a 200 OK response is sent from Device A's SIP client 200 to Device B's SIP client 200 (step f). This response includes an SDP message body indicating the requested session parameters have been accepted. The SIP client 200 for the calling party acknowledges the SIP 200 OK response by sending a SIP ACK message (step g). The SIP ACK may contain an SDP message body if the initial INVITE did not include an SDP message body. This exchange of messages allows an RTP or MSRP session to be established (step h). When the call is complete, the user application 150 for one party sends a HANGUP request to the SIP client 200 (step i). The SIP client 200 terminates the session using the BYE method, where the SIP client 200 sends a BYE request to the other party (step j). The SIP client 200 indicates to the user application 150 that the call is ended (step k) and sends a SIP 200 OK response to confirm receipt of the BYE request and to terminate the session (step I).

In the simple example above, it can be seen that the amount of signaling between user application 150 and SIP client 200 is small compared to the signaling between SIP clients 200 needed to establish the communication session. Further, the messages sent by user application 150 will be small in size compared to typical SIP messages. Commands from the user application 150 to the SIP client 200 may comprise only a few bytes, whereas the SIP messages typically comprise hundreds of bytes. Because SIP client 200 creates a high-level application interface (i.e., the UA interface 208), there is a potential for significant reduction in bandwidth requirements, latency, and/or costs by locating the SIP client 200, or various components such as the UA 202 and SA 206, in a network.

When the SIP clients 200 are embedded applications in the end devices, the SIP signaling must traverse the communication networks between the end devices. In the example shown in FIG. 1, all of the SIP messages traverse both the cellular network 20 and IMS network 30. In IMS network 30, the SIP messages may traverse numerous SIP proxies before reaching their final destination. If it is assumed that each user command by the user application 150 comprises 20 bytes and results in the generation of six SIP messages averaging 200 bytes each, the total network loading is 1200 bytes per user command. The term “user command,” as used herein, refers to commands issued by the user application 150 to the UA 202 component of the SIP client 200. Because the components of the SIP client 200, such as the UA 202 and SA 206, may be located anywhere in a complex network, network optimization and cost reduction may be achieved by locating these components where the associated SIP messages can be most efficiently delivered.

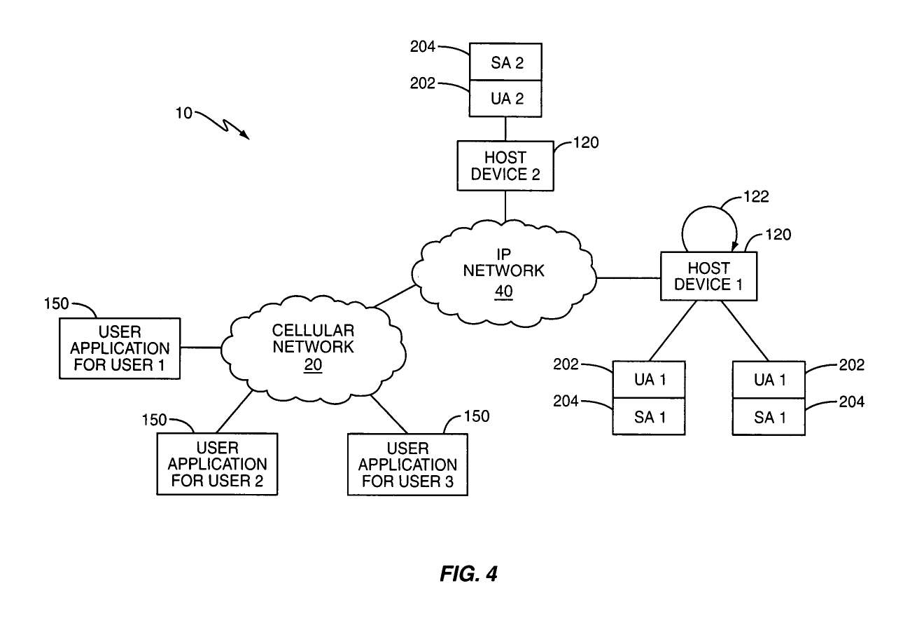

FIG. 4 shows an implementation of the SIP client 200 in which the UA 202 and SA 206 are located in a remote network that offers lower costs. The location of the MA 204 is not considered in this example, but could reside in the end devices. Three users are connected to a cellular network 40. Cellular network 20 is connected by a gateway (not shown) to a remote IP network 40. The UA 202 and SA 206 for users 1 and 3 are hosted on a first host device 120 denoted herein as Host Device 1. The UA 202 and SA 206 for user 2 is hosted on a separate host device 120 denoted as Host Device 2. In this example, suppose that the user application 150 for User 1 wants to establish a call with User 2. The user application 150 for User 1 sends a user command (e.g. a CALL command) to its UA 202, which is connected to IP network 50. Again, it is assumed that each user command by the user application 150 comprises 20 bytes and results in the generation of six SIP messages averaging 200 bytes each. The relatively low bandwidth user command is transmitted to the cellular network 40 and then routed through to User 1's corresponding UA 202 in the IP network 50. The total network loading on the cellular network is 20 bytes, compared to the 1200 bytes (assuming six SIP messages per user command) for an NCD with embedded SIP client 200. If the cost per byte in the remote network is 25% of the cost on the cellular network, overall costs are reduced by a factor of 3.75.

Further reduction in costs can be realized if UAs 202 for the called party and calling party are hosted on the same host device 120. Referring again to FIG. 4, UA 1 and UA 3 reside on the same host device 120. If User 1 wants to call User 3, no SIP messages need to be sent over any physical network. Instead, all SIP signaling can occur over a loop-back interface 122 on the host device 120, which results in a virtual network. In this case, the cost is reduced by a factor of 60, compared to the original configuration shown in FIG. 1.

The above examples illustrate how the inherent compression property of the application interface 208 for the UA 202 can be used to optimize network performance and reduce costs. In general, a network can be characterized in terms of metrics such as costs, bandwidth, and latency. Location of the UA 202, MA 204, and SA 206 affects each of these metrics in a known way. Based on a weighting of these metrics, service providers can design a network topology that optimizes system performance.

In the embodiments shown above, there is one instance of the SIP client 200 with one user agent for each IMS user. Each SIP client 200 has a separate IP address (or host port). In large networks with many IMS users, depletion of IP address space may be a concern. Further, a priori knowledge of the IP address of users, or some discovery process to determine IP addresses, is needed. Also, this embodiment does not scale easily, and the maintenance and upgrade of a large number of user agents is problematic.

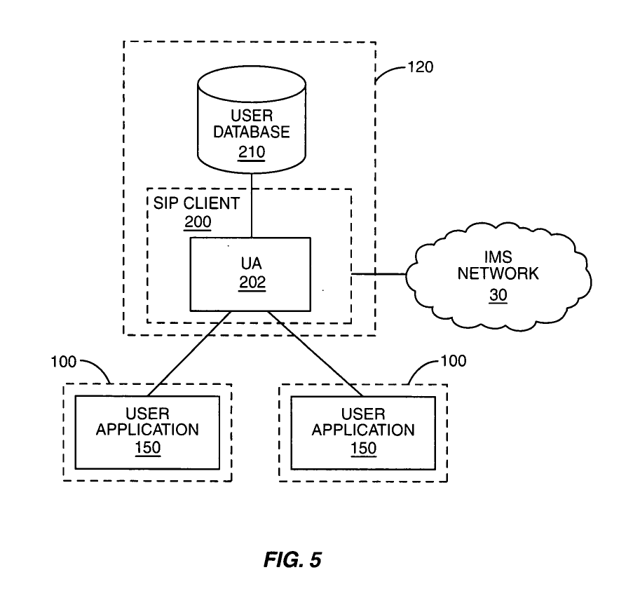

FIG. 5 illustrates an implementation of the SIP client 200 using a shared UA 202. Because the signaling agent 204 and media agent 206 components may be implemented independently of the UA 202, they are not shown in the diagram. In this example, a single UA 202 in a host device 120 provides services to multiple users, represented by user applications 150 in NCDs 100. All users can share the same network address. Nevertheless, those skilled in the art will appreciate that the UA 202 could use more than one network address. The UA 202 uses a TCP socket connection or other type of network interface to communicate with the user applications 150 as previously described. The UA 202 can reside on a host device 120 in the network and can control one or more MAs 206 and SAs 204 to perform media and signaling operations respectively. A single SA 204 for a plurality of users can be collocated with the UA 202. The MAs 206 may reside in the end NCDs 100.

The use of a shared UA 202 has a number of advantages over distinct UAs 202 for each user. Users sharing the same UA 202 and network address can communicate without the need for SIP registration services. Also, the shared implementation of the user agent 202 scales readily to accommodate large networks and reduces maintenance and upgrade costs.

In one embodiment, the shared UA 202 maintains a table or user database 210 containing the user identity and state information for each connected user. The UA 202 may allocate a dedicated TCP socket connection for each user. The user identity is associated with the TCP socket connection and state information in the user database 210 or table. If the host device 120 uses a multi-threading operating system, the UA 202 may, alternatively, create separate threads in the UA process for each user. Using multi-threading techniques, the UA 202 is relieved of the need to maintain state information for each user.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A SIP client for networked communication devices, comprising:
a shared user agent to communicate with a plurality of user applications in one or more communication devices, said user agent operative to receive application commands from said user applications and to translate said application commands into signaling and media operations;
a signaling agent under the control of the user agent to perform signaling operations to establish and terminate communication sessions; and
a media agent under the control of the user agent to perform media operations to send and receive multimedia messages.

2. The SIP client of claim 1 wherein said user agent uses a first network interface for communications between the user agent and the user application.

3. The SIP client of claim 2 wherein the user agent is located remotely from the user application.

4. The SIP client of claim 3 wherein the user agent resides in a server within a communication network, and wherein the user applications reside in respective communication devices and remotely access the user agent.

5. The SIP client of claim 4 wherein the signaling agent and media agent also reside within the server.

6. The SIP client of claim 1 wherein said user agent communicates with each user application using a dedicated address.

7. The SIP client of claim 7 wherein said user agent maintains a user database relating each dedicated address with a user application.

8. The SIP client of claim 1 wherein said user agent communicates with each user application over a shared address.

9. A method of establishing a media session for a communication device comprising:
receiving user commands from a plurality of user applications at a shared user agent;
translating said user commands into signaling and media operations by said shared user agent; and
controlling a signaling agent and media agent respectively to perform said signaling and media operations.

10. The method of claim 9 wherein said user agent uses a first network interface for communications between the user agent and said user applications.

11. The method of claim 10 wherein the user agent is located remotely from said user applications.

12. The method of claim 11 wherein the user agent user agent resides in a server within a communication network, and wherein the user applications reside in respective communication devices and remotely access the user agent.

13. The method of claim 12 wherein the signaling agent and media agent also reside within the server.

14. The method of claim 9 wherein said user agent communicates with each user application using a dedicated address.

15. The method of claim 14 wherein said user agent maintains a table relating each address with a user application.

16. The method of claim 9 wherein said user agent communicates with each user application over a shared address.

17. A communication system comprising:
a user application residing in a first communication device connected to a first network; and
a SIP client residing in a host device connected to a second network to perform signaling operations on behalf of said user application responsive to user commands from said user application such that signaling messages generated during said signaling operations do not traverse said first network.

18. The communication system of claim 17 wherein said signaling operations are performed to establish a communication session between said first communication device and a second communication device.

19. The communication system of claim 17 wherein said SIP client comprises:
a user agent having a high-level application interface to communicate with said user application and to translate said user commands from said user application into signaling operations; and
a signaling agent under the control of the user agent to generate signaling messages to perform said signaling operations.

20. The communication system of claim 17 wherein said host device comprises a server.

21. A method of reducing signaling overhead traversing a first network, said method comprising:
sending a user command from a user application residing in a first communication device to a SIP client residing in a host device connected to a second network; and
performing signaling operations by said SIP client on behalf of said user application responsive to said user commands such that signaling messages generated during said signaling operations do not traverse said first network.

22. The method of claim 21 wherein said signaling operation are performed to establish a communication session between said first communication device and a second communication device.

23. The method of claim 21 wherein performing signaling operations by said SIP client on behalf of said user application comprises translating said user commands into corresponding signaling operations and generating signaling messages to perform said signaling operations.

24. The method of claim 23 wherein translating said user commands into corresponding signaling operations is performed by a user agent.

25. The method of claim 24 wherein generating signaling messages to perform said signaling operations is performed by a signaling agent under the control of said user agent.

26. The method of claim 21 wherein said host device comprises a server.
